(19) United States
(12) Patent Application Publication
(10) Pub. No.: US 2022/0182853 A1
(43) Pub. Date: Jun. 9, 2022

(54) AUTOMATIC HANDLING OF NETWORK COMMUNICATION FAILURE IN TWO-DIMENSIONAL AND THREE-DIMENSIONAL COORDINATE MEASUREMENT DEVICES

(71) Applicant: FARO Technologies, Inc., Lake Mary, FL (US)

(72) Inventors: Kalyan Nagalla, Downingtown, PA (US); Kiranmayi Yelamanchili, Downingtown, PA (US); James Harris, Haddonfield, NJ (US)

(21) Appl. No.: 17/501,046

(22) Filed: Oct. 14, 2021

Related U.S. Application Data
(60) Provisional application No. 63/120,838, filed on Dec. 3, 2020.

(51) Int. Cl. H04W 24/04; G01B 11/00

(52) U.S. Cl. CPC H04W 24/04; G01B 11/005

(57) ABSTRACT

A method includes establishing a first communication connection between a computing device and a coordinate measurement device for submitting, by the computing device, one or more commands to the coordinate measurement device. A second communication connection between the two devices is established for receiving, by the computing device, coordinate data from the coordinate measurement device. In response to receiving, by the computing device, a command for the coordinate measurement device, if the first communication connection is not open, a wait is performed for the first communication connection to re-establish. If the wait is less than a predetermined duration, the method includes re-establishing, by the computing device, one or more channels for the first communication connection.

### CROSS REFERENCE TO RELATED APPLICATIONS

This application claims the benefit of U.S. Provisional Application Ser. No. 63/120,838, filed Dec. 3, 2020, the entire disclosure of which is incorporated herein by reference.

### BACKGROUND

The present application is directed to a system that optically scans an environment, such as a building, and in particular, to a mobile measurement system that generates two-dimensional (2D) and three-dimensional (3D) scans of the environment. Further, the present application is directed to automatic handling of network communication failures during such the scanning process.

Automated measurement of coordinates of surfaces in an environment is desirable as a number of measurements or scans may be performed in order to obtain the desired data. Various techniques may be used, such as time-of-flight (TOF) or triangulation methods, for example. A TOF laser scanner is a scanner in which the distance to a target point is determined based on the speed of light in air between the scanner and a target point. Laser scanners are typically used for scanning closed or open spaces such as interior areas of buildings, industrial installations, and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., azimuth and zenith angle), and optionally a gray-scale value. This raw scan data is collected, stored, and sent to a processor or processors to generate an image, 2D/3D, representing the scanned area or object. Generating an image requires at least three values for each data point. These three values may include the distance and two angles or may be transformed values, such as the x, y, z coordinates. In an embodiment, an image is also based on a fourth gray-scale value, which is a value related to the irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducers). The beam steering mechanism also includes a second motor that steers the beam of light about a second axis by a second angle that is measured by a second angular encoder (or other angle transducers).

Many contemporary laser scanners include a camera mounted on the laser scanner for gathering camera digital images of the environment and for presenting the digital camera images to an operator of the laser scanner. By viewing the camera images, the operator of the scanner can determine the field of view of the measured volume and adjust settings on the laser scanner to measure over a larger or smaller region of space. In addition, the digital images from the camera may be transmitted to a processor to add color to the scanner image. To generate a color scanner image, at least three positional coordinates (such as x, y, z) and three color values (such as red, green, blue “RGB”) are collected for each data point.

In contrast, a triangulation system, such as a scanner, projects either a line of light (e.g., from a laser line probe) or a pattern of light (e.g., from a structured light) onto the surface. In this system, a camera is coupled to a projector in a fixed mechanical relationship. The light/pattern emitted from the projector is reflected off of the surface and detected by the camera. Since the camera and projector are arranged in a fixed relationship, the distance to the object may be determined from captured images using trigonometric principles. Triangulation systems provide advantages in quickly acquiring coordinate data over large areas.

Yet another type of measurement system is referred to as a laser tracker, sometimes also referred to as a total station or a theodolite. In a laser tracker, the tracker emits a beam of light onto a reflective target, such as a spherically mounted retroreflector, for example. The reflected light is received by the tracker, and the distance to the reflective target is determined, such as with an absolute distance meter. The operator moves the reflective target against the object to be measured and triggers a measurement by emitting and receiving the light beam with the laser tracker. Laser trackers typically rotate about two axes, allowing for three-dimensional coordinates to be determined. Laser trackers are typically used to accurately measure large objects.

Accordingly, while existing coordinate measurement devices are suitable for their intended purposes, what is needed is a coordinate measurement device having certain features of embodiments of the present disclosure.

### BRIEF DESCRIPTION

According to one or more embodiments, a system includes a coordinate measurement device configured to capture coordinate data. The system also includes a computing device communicatively coupled with the coordinate measurement device. The computing device establishes a first communication connection with the coordinate measurement device for submitting one or more commands to the coordinate measurement device. The computing device further establishes a second communication connection with the coordinate measurement device for receiving scanned data from the coordinate measurement device. The computing device, further, in response to receiving a command for the coordinate measurement device, determines that the first communication connection is not open and waits for the first communication connection to re-establish. Further, in response to a wait for re-establishing the first communication connection being less than a predetermined duration, the computing device re-establishes one or more channels for the first communication connection.

According to one or more embodiments, a computer-implemented method is described for detecting a communication connection loss and re-establishing a communication connection between a coordinate measurement device and a computing device. The method includes establishing a first communication connection between the computing device and the coordinate measurement device for submitting, by the computing device, one or more commands to the coordinate measurement device. The method further includes establishing a second communication connection between the computing device and the coordinate measurement device for receiving, by the computing device, coordinate data from the coordinate measurement device. The method further includes, in response to receiving, by the computing device, a command for the coordinate measurement device, determining that the first communication connection is not open, and waiting for the first communication connection to re-establish. Further, in response to a wait for re-establishing the first communication connection being less than a predetermined duration, the method includes re-establishing, by the computing device, one or more channels for the first communication connection.

According to one or more embodiments, a system includes a memory, and one or more processors coupled with the memory, and communicatively coupled with a coordinate measurement device that is configured to capture coordinate data. The one or more processors establish a first communication connection with the coordinate measurement device for submitting one or more commands to the coordinate measurement device. The one or more processors further establish a second communication connection with the coordinate measurement device for receiving scanned data from the coordinate measurement device. In response to receiving a command for the coordinate measurement device, the one or more processors determine that the first communication connection is not open and wait for the first communication connection to re-establish. In response to a wait for re-establishing the first communication connection being less than a predetermined duration, the one or more processors re-establish one or more channels for the first communication connection.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages are apparent from the following detailed description taken in conjunction with the accompanying drawings in which:

FIG. 1 depicts a system for scanning an environment according to one or more embodiments of the present disclosure;

FIG. 2 depicts a block diagram for using sensor data for simultaneously locating and mapping a scanner in an environment according to one or more embodiments of the present disclosure;

FIG. 3 depicts a flowchart of a method for detecting a loss in and re-establishing a communication connection between a communication-server and a communication-client according to one or more embodiments;

FIG. 4 depicts an embodiment of a scanner according to one or more embodiments of the present disclosure;

FIG. 5 depicts an embodiment of a scanner according to one or more embodiments of the present disclosure;

FIG. 6 depicts an embodiment of a scanner according to one or more embodiments of the present disclosure;

FIG. 7 depicts an embodiment of a scanner according to one or more embodiments of the present disclosure;

FIG. 8 depicts an embodiment of a scanner according to one or more embodiments of the present disclosure;

FIG. 9 depicts an embodiment of a scanner according to one or more embodiments of the present disclosure;

FIG. 10 depicts an embodiment of a laser tracker device;

FIG. 11 is an illustration of a laser tracker device for use with the laser tracker system of FIG. 10;

FIG. 12 is a block diagram of a control system of the laser tracker device of FIG. 11;

FIG. 13 is a block diagram of elements in a laser tracker device in accordance with one or more embodiments of the invention; and

FIG. 14 depicts a computing system that can implement one or more embodiments of the present disclosure.

The detailed description explains embodiments, together with advantages and features, by way of example, with reference to the drawings.

### DETAILED DESCRIPTION

Embodiments of the present disclosure provide technical solutions to technical challenges in existing coordinate measurement systems. The measurement systems can capture two-dimensional or three-dimensional (3D) scans or measurements. Such measurements/scans can include 3D coordinates, 2D maps, 3D point clouds, or a combination thereof. The measurements/scans can include additional components, such as annotations, images, textures, measurements, and other details.

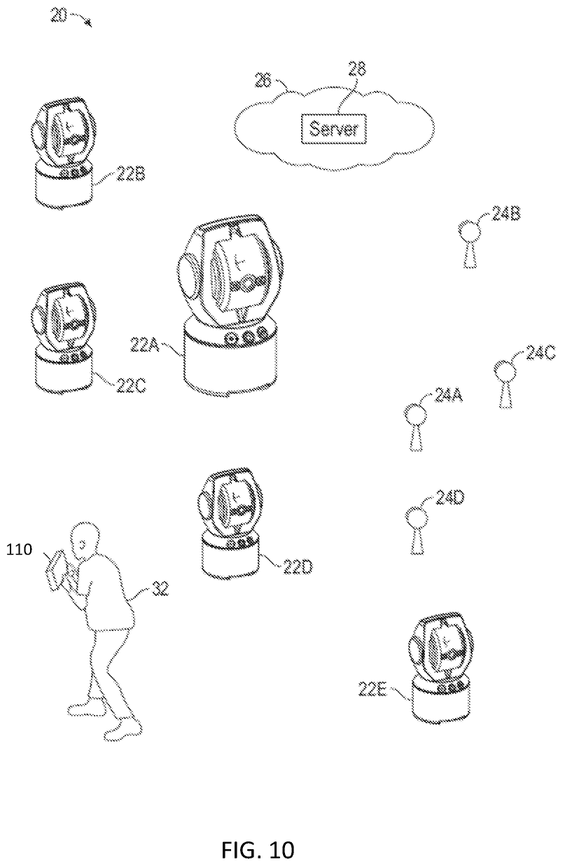

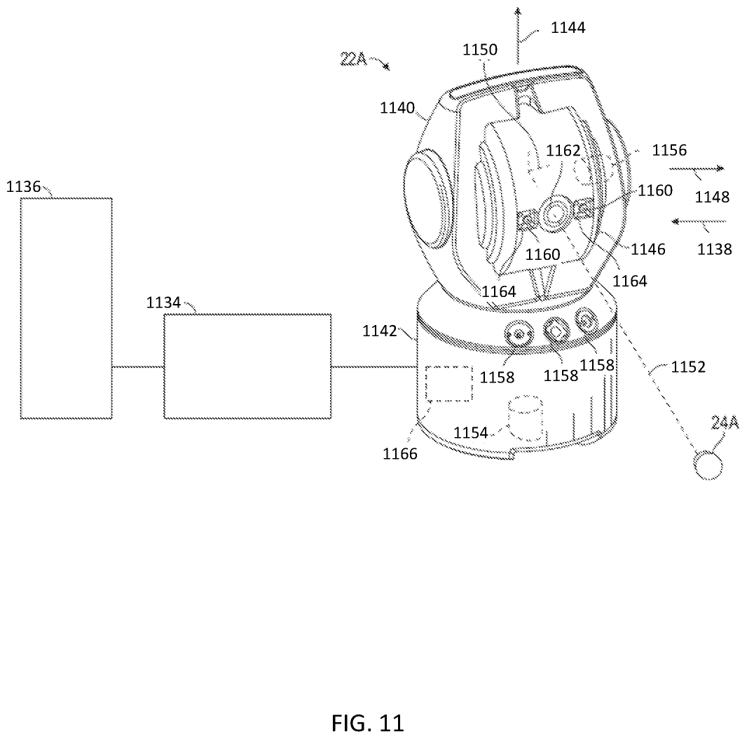

A laser tracker device is a metrology device that measures positional coordinates using laser light. Laser tracker devices of the type discussed herein may be used in manufacturing environments where it is desired to measure objects, parts, or assemblies with a high level of accuracy. It should be appreciated that in some applications, multiple laser tracker devices may be used and may be positioned in locations that are distant from an operator. An exemplary embodiment of a laser tracker system 20 is provided that allows an operator or user to control and operate the functions of a desired laser tracker device is illustrated in FIG. 10 (described later herein).

The laser tracker system 20 includes at least one laser tracker device 22A and may include a plurality of laser tracker devices 22B-22E. System 20 further includes at least one retroreflective target 24A and may include a plurality of retroreflective targets 24B-24D. As will be discussed in more detail herein, the retroreflective targets 24A-24D cooperate with laser light emitted by the laser tracker devices 22A-22E to allow a laser tracker device to measure the distance between the laser tracker device and the retroreflective target. With the distance to the retroreflective device determined, angular measurement devices, such as angular encoders, for example, in the laser tracker device, allow for the determination of the coordinates of the retroreflective device in a laser tracker device frame of reference.

System 20 further includes a computer network 26 that may include one or more nodes 28, such as a computer server, for example. The computer network 26 may be any known computer network, such as but not limited to a local area network (LAN), a wide-area network (WAN), a cellular network, or the Internet, for example. In an embodiment, each of the laser tracker devices includes communications circuits, such as Ethernet (IEEE 802.3), WiFi (IEEE 802.11), or cellular communications circuits, for example, that are configured to transmit to and receive signals from the computer network 26. The system 20 further includes at least one mobile computing device 30. As will be discussed in more detail herein, the mobile computing device 30 includes communications circuits that allow the mobile computing device 30 to transmit to and receive signals from the computer network. As will be discussed in more detail herein, the computer network 26 allows the mobile computing device 30 to transmit signals to and receive signals from one or more of the laser tracker devices 22A-22E.

As used herein, the term “mobile computing device” refers to a computing device having one or more processors, a display, and non-transitory memory that includes computer-readable instructions. The mobile computing device also includes a power source, such as a battery for example, that allows a user to move about the environment with the mobile computing device. The mobile computing device is sized and shaped to be carried by a single person. In an embodiment, the mobile computing device may be but is not limited to a cellular phone, a smartphone, a personal digital assistant, a tablet computer, a laptop computer, or a convertible laptop computer, for example.

Other types of coordinate measurement devices measure an area as opposed to discrete points, as is done in the laser tracker of FIG. 10. Since coordinate points for an area are being measured simultaneously, this measurement process is sometimes referred to as a “scan.” Typically, when capturing a scan of an environment, a version of the simultaneous localization and mapping (SLAM) algorithm is used. For completing such scans, a scanner, such as the FARO® SCANPLAN®, FARO® SWIFT®, FARO® FREESTYLE®, or any other measurement system incrementally builds the scan of the environment, while the scanner is moving through the environment, and simultaneously the scanner tries to localize itself on this scan that is being generated. An example of a handheld scanner is described in U.S. patent application Ser. No. 15/713,931, the contents of which are incorporated by reference herein in its entirety. This type of scanner may also be combined with another scanner, such as a time of flight scanner, as is described in commonly owned U.S. patent application Ser. No. 16/567,575, the contents of which are incorporated by reference herein in its entirety. It should be noted that the scanners listed above are just examples and that the type of scanner used in one or more embodiments does not limit the features of the technical solutions described herein.

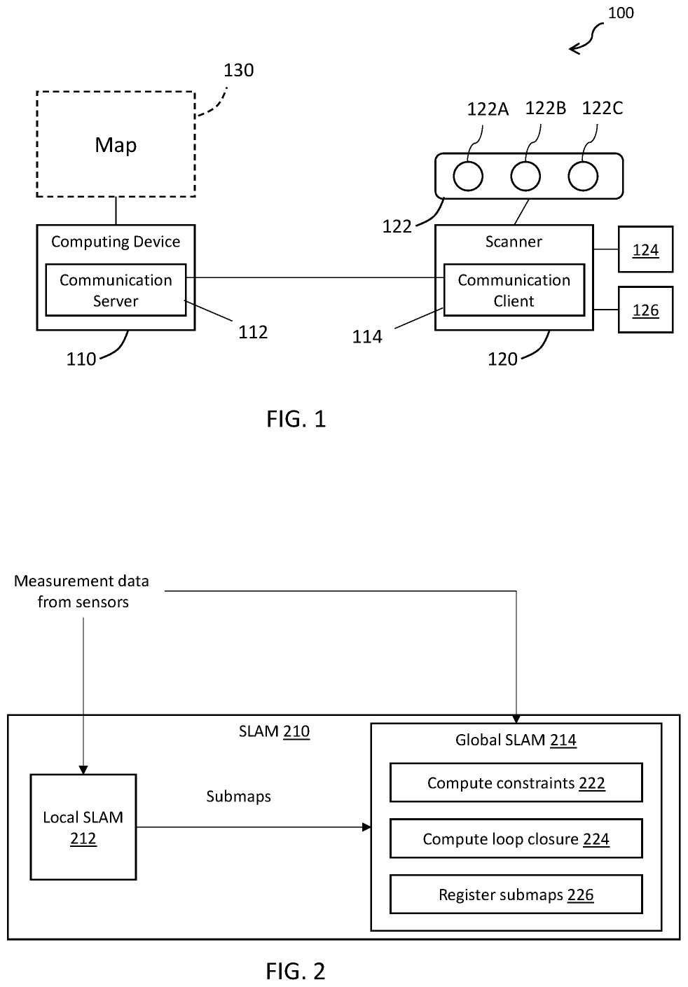

FIG. 1 depicts a system for capturing coordinates in an environment according to one or more embodiments of the present disclosure. The measurement system 100 includes a computing system 110 coupled with a coordinates-measurement device 120. The coupling facilitates wired and/or wireless communication between the computing system 110 and the coordinates-measurement device 120. The coordinates-measurement device 120 can include a laser tracker, a 2D scanner, a 3D scanner, or a combination thereof. The coordinates-measurement device 120 captures measurements of the surroundings of the coordinates-measurement device 120. The measurements are transmitted to the computing system 110 to generate a map 130 of the environment in which the coordinates-measurement device 120 is being moved, in one or more embodiments. Map 130 can be generated by combining several sub-maps. Each sub-map is generated using SLAM.

FIG. 2 depicts a high-level operational flow for implementing SLAM according to one or more embodiments of the present disclosure. Implementing SLAM 210 includes generating one or more sub-maps corresponding to one or more portions of the environment. The sub-maps are generated using one or more sets of measurements from the sets of sensors 122. Generating the sub-maps may be referred to as “local SLAM” (212). The sub-maps are further combined by the SLAM algorithm to generate map 130. Combining the sub-maps process may be referred to as “global SLAM” (214). Together, generating the sub-maps and the final map 130 of the environment is referred to herein as implementing SLAM, unless specifically indicated otherwise.

It should be noted that the operations shown in FIG. 2 are at a high level and that the typical implementation of SLAM 210 can include operations such as filtering, sampling, and others, which are not depicted.

The local SLAM 212 facilitates inserting a new set of measurement data captured by the coordinates-measurement device 120 into a sub-map construction. This operation is sometimes referred to as “scan matching.” A set of measurements can include one or more point clouds, a distance of each point in the point cloud(s) from the coordinates-measurement device 120, color information at each point, radiance information at each point, and other such sensor data captured by the set of sensors 122 that is equipped on the coordinates-measurement device 120. For example, sensors 122 can include a LIDAR 122A, a depth camera 122B, a camera 122C, etc. The coordinates-measurement device 120 can also include an inertial measurement unit (IMU) 126 to keep track of a 3D orientation of the coordinates-measurement device 120.

The captured measurement data is inserted into the sub-map using an estimated pose of the coordinates-measurement device 120. The pose can be extrapolated by using the sensor data from sensors 122, the IMU 126, and/or from sensors besides the range finders to predict where the scanned measurement data is to be inserted into the sub-map. Various techniques are available for scan matching. For example, a point to insert the measured data can be determined by interpolating the sub-map and sub-pixel aligning the scan. Alternatively, the measured data is matched against the sub-map to determine the point of insertion. A sub-map is considered complete when the local SLAM 212 has received at least a predetermined amount of measurement data. Local SLAM 212 drifts over time, and global SLAM 214 is used to fix this drift.

It should be noted that a sub-map is a representation of a portion of the environment and that map 130 of the environment includes several such sub-maps “stitched” together. Stitching the maps together includes determining one or more landmarks on each sub-map that is captured and aligning and registering the sub-maps with each other to generate map 130. In turn, generating each sub-map includes combining or stitching one or more sets of measurements from the sensors 122. Combining two sets of measurements requires matching or registering one or more landmarks in the sets of measurements being combined.

Accordingly, generating each sub-map and further combining the sub-maps includes registering a set of measurements with another set of measurements during the local SLAM (212), and further, generating map 130 includes registering a sub-map with another sub-map during the global SLAM (214). In both cases, the registration is done using one or more landmarks.

Here, a “landmark” is a feature that can be detected in the captured measurements and which can be used to register a point from the first set of measurements with a point from the second set of measurements. For example, the landmark can facilitate registering a 3D point cloud with another 3D point cloud or to register an image with another image. Here, the registration can be done by detecting the same landmark in the two measurements (images, point clouds, etc.) that are to be registered with each other. A landmark can include but is not limited to features such as a doorknob, a door, a lamp, a fire extinguisher, or any other such identification mark that is not moved during the scanning of the environment. The landmarks can also include stairs, windows, decorative items (e.g., plant, picture frame, etc.), furniture, or any other such structural or stationary objects. In addition to such “naturally” occurring features, i.e., features that are already present in the environment being scanned, landmarks can also include “artificial” landmarks that are added by the operator of the coordinates-measurement device 120. Such artificial landmarks can include identification marks that can be reliably captured and used by the coordinates-measurement device 120. Examples of artificial landmarks can include predetermined markers, such as labels of known dimensions and patterns, e.g., a checkerboard pattern, a target sign, or other such preconfigured markers.

The global SLAM (214) can be described as a pose graph optimization problem. As noted earlier, the SLAM algorithm is used to provide concurrent construction of a model of the environment (the scan) and an estimation of the state of the coordinates-measurement device 120 moving within the environment. In other words, SLAM gives you a way to track the location of a robot in the world in real-time and identify the locations of landmarks such as buildings, trees, rocks, walls, doors, windows, paintings, décor, furniture, and other world features. In addition to localization, SLAM also builds up a model of the environment to locate objects, including the landmarks that surround the coordinates-measurement device 120 and so that the scan data can be used to ensure that the coordinates-measurement device 120 is on the right path as the coordinates-measurement device 120 moves through the world, i.e., environment. So, the technical challenge with the implementation of SLAM is that while building the scan, the coordinates-measurement device 120 itself might lose track of where it is by virtue of its motion uncertainty because there is no presence of an existing map of the environment (the map is being generated simultaneously).

The basis for SLAM is to gather information from the set of sensors 120 and motions over time and then use information about measurements and motion to reconstruct a map of the environment. The SLAM algorithm defines the probabilities of the coordinates-measurement device 120 being at a certain location in the environment, i.e., at certain coordinates, using a sequence of constraints. For example, consider that the coordinates-measurement device 120 moves in some environment, the SLAM algorithm is input the initial location of the coordinates-measurement device 120, say (0,0) initially, which is also called as Initial Constraints. The SLAM algorithm is then provided with several relative constraints that relate each pose of the coordinates-measurement device 120 to a previous pose of the coordinates-measurement device 120. Such constraints are also referred to as relative motion constraints.

The technical challenge of SLAM can also be described as follows. Consider that the coordinates-measurement device 120 is moving in an unknown environment, along a trajectory described by the sequence of random variables x_{1:T}={x₁, . . . , x_{T}}. While moving, the coordinates-measurement device 120 acquires a sequence of odometry measurements u_{1:T}={u_{I}, . . . , u_{T}} and perceptions of the environment z_{I:T}={z₁, . . . , z_{T}}. The “perceptions” include the captured data and the mapped detected planes 410. Solving the full SLAM problem now includes estimating the posterior probability of the trajectory of the coordinates-measurement device 120 x_{1:T} and the map M of the environment given all the measurements plus an initial position x₀: P(x_{1:T}, M|z_{I:T}, u_{1:T}, x₀). The initial position x₀ defines the position in the map and can be chosen arbitrarily. There are several known approaches to implement SLAM, for example, graph SLAM, multi-level relaxation SLAM, sparse matrix-based SLAM, hierarchical SLAM, etc. The technical solutions described herein are applicable regardless of which technique is used to implement SLAM.

Referring to FIG. 1 again, to facilitate communication of data between the coordinates-measurement device 120 and the computing device 110, a wired/wireless network is established between the coordinates-measurement device 120 and the computing device 110. The communication can be performed using client-server architecture, for example, with a communication-server 112 operating on the computing device 110 and a corresponding communication-client 114 operating on the coordinates-measurement device 120. In other embodiments, the communication-server 112 can be on the coordinates-measurement device 120, and the communication-client 114 on the computing device 110. The communication-server 112 and the communication-client 114 can be implemented using one or more computer-executable instructions.

The communication is performed using one or more known communication protocols, for example, Ethernet-based communication using transmission control protocol/Internet protocol (TCP/IP), user datagram protocol (UDP), file transfer protocol (FTP), or any other such communication protocols. In one or more embodiments, a first communication protocol, such as TCP/FTP, is used for communicating commands, and a second communication protocol, such as UDP, is used for data transfer.

A technical challenge with such an architecture of the measurement system is that a communication failure can prevent commands and data from being transferred between the coordinates-measurement device 120 and the computing device 110. Particularly in the case of wireless communication being used in an environment in which several other wireless communication connections/devices exist, communication failure can occur frequently. Such communication failures include the communication-client 114 losing its connection with the communication-server 112. Although the connection can be re-established after such a loss of the connection, however momentary, such a communication failure can lead to one or more user interactions required to cure the communication failure. Further, communication protocols such as TCP and FTP, which are connection-based, i.e., the two sides (server and client) have to establish a handshake to exchange information. For such communication protocols, it is imperative that the communication connection is not interrupted once established because the pipes/communication channels have to be re-established to restore the data exchange using the connection. Such re-establishment is, thus, expensive and resource-intensive. In the case of communication protocols such as UDP, which are broadcast-based, although a connection does not have to be re-established, if the connection is lost, a sender of the communication (communication-server 112 or communication-client 114) can transmit a packet and be oblivious that a receiver is not receiving the communication. Thus, in such cases, communication can be lost.

The communication failure can be exacerbated in environments in which multiple physical objects exist that can reduce the strength of the wireless communication signal between the communication-server 112 and the communication-client 114. Additionally, as the coordinates-measurement device 120 is moved through the environment, with the computing device 110 being stationary, the strength of the wireless communication signal can vary, causing the communication failures frequently, particularly in areas where the strength is below a predetermined threshold (e.g., −60 dBm, etc.). A typical workaround to overcome the communication failure includes using a wired connection between the computing device 110 and the coordinates-measurement device 120. However, using such a wired connection adversely affects the mobility of the coordinates-measurement device 120. Another workaround to avoid the communication failure includes having two operators, a first operator for the coordinates-measurement device 120 and a second operator for the computing device 110, who ensure that the distance between the two devices does not exceed a predetermined distance threshold. Neither of these workarounds is efficient nor cost-effective.

Embodiments of the technical solutions described herein address such technical challenges with the communication failures by detecting the communication failure and re-establishing the connection without any user interruption. It should be noted that although communication failures are more common with wireless connections, wired connections can also experience such communication failures. Embodiments of the technical solutions described herein address the communication failures in the case of both wireless and wired connections.

It should be noted that the communication failures described herein are also commonly referred to as a “glitch” in communication because of the sudden and usually temporary malfunction or irregularity of the connection.

As noted earlier, to cure such a glitch in the case of connection-based communication protocols, re-establishing the connection has substantial overhead. The technical challenge can be further complicated if the glitch is experienced midway during a transaction. For example, if a command is submitted from the computing device 110 to the coordinates-measurement device 120 and while the coordinates-measurement device 120 is executing that command, the connection is lost. In existing systems, the computing device 110 can detect the loss in connection and re-establish the connection in response; however, the computing device 110 cannot determine whether the command that was transmitted was successfully executed or not and whether to re-issue the command. In typical solutions, the computing device 110 re-issues the command by default, which is inefficient, and further, can contribute to workflow interruptions for the operator of the coordinates-measurement device 120.

Yet another technical challenge with the communication setup between the communication-server 112 and the communication-client 114 is that only one instance of the communication-server 112 can control (by sending commands) the coordinates-measurement device 120 even if the environment can include additional computing devices (similar to the computing device 110) that are capable of controlling the coordinates-measurement device 120. The existing communication setup prevents two different computing devices controlling the same coordinates-measurement device 120 at the same time, for example, a first computing device 110 sends a command to the coordinates-measurement device 120 to move to in a first direction (e.g., right), while a second computing device 110 sends a command to the coordinates-measurement device 120 in a second direction (e.g., left). In another embodiment, the first computing device 110, whichever submits the command first, is configured to be the “master” controller that controls the coordinates-measurement device 120, while the second computing device 110 (and any more) can only read data from the coordinates-measurement device 120. Now consider the case where the master controller, i.e., the first computing device 110, loses communication midway during a command. In existing systems, the coordinates-measurement device 120 refuses the first computing device 110 to re-establish the connection because the coordinates-measurement device 120 has configured the previous instance of the communication-server 112 as the master controller.

Embodiments described herein address such technical challenges that include the coordinates-measurement device 120 detecting a lost connection and in response providing handshake messages during the reconnection to facilitate the same “master” to access the new connection. Also, the previous command's response is also supplied to the computing device upon such reconnection. Accordingly, the computing device 110 does not have to re-send an already executed command.

In one or more embodiments, the re-establishment of the connection is performed silently, without any operator messages, and/or any operator interruption/disruption where the operator has to respond to one or more messages/pop-ups. Such a silent re-establishment of the connection is performed when the duration of the glitch is less than a predetermined threshold, for example, 2 seconds, 3 seconds, 5 seconds, or any other such threshold. If the duration of the glitch is beyond the predetermined threshold, a message can be shown to the operator to re-establish the connection. Such a longer glitch can typically occur in the case of wired connections. Once the physical connection is re-established by the operator in case of such a longer glitch, the communication is re-established in a silent manner, with the coordinates-measurement device 120 identifying the same master controller. However, if the glitch exists for a duration of at least a second predetermined threshold, the operator is notified that a potentially serious communication failure has occurred that may need his/her attention.

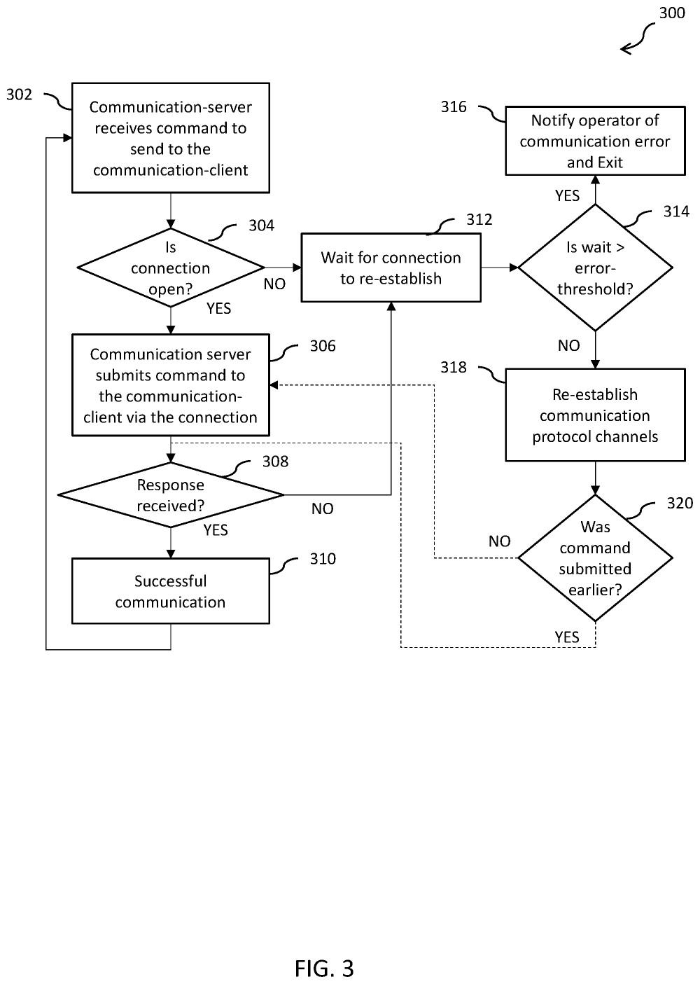

FIG. 3 depicts a flowchart for a method 300 for re-establishing a lost communication connection between a coordinates measurement device and a computing device according to one or more embodiments. Method 300 includes the communication server 112 of the computing device 110 receiving a command to be sent to the coordinates-measurement device 120, at block 302. The communication-server 112 sends the command(s) to the coordinates-measurement device 120 via the communication-client 114 using a connection-based communication protocol, such as FTP.

The communication-server 112 checks that the communication connection with the communication-client 114 is open, at block 304. Checking whether the connection is open can be performed using one or more known techniques, such as using the “ping” command or any other technique. The connection is a known communication connection of the communication-server 112 with the known communication-client 114. In one or more embodiments, the communication-server 112 establishes the connection with the communication-client using a service set identifier (SSID) of the communication-client 114.

If the connection is open, the command is submitted to the communication-client 114 via the connection, at block 306. Further, the communication-server 112 monitors to check if a response to the command is obtained at block 308. If a response is received within a predetermined threshold, the communication is deemed successful, and method 300 can be repeated for further communication at block 310.

Instead, if at block 304, it is detected that the connection is not open, the communication-server 112 waits for the connection to be re-established with the hardware of the communication-client 114, at block 312. Such a re-establishment can include, in the case of a wireless connection, the communication-server 112 connecting with the SSID of the communication-client 114. Alternatively, or in addition, the re-establishment can include a physical connection, such as an Ethernet cable, being established between the communication-server 112 and the communication-client 114. The communication-server 112 identifies that the connection is with the same communication-client 114 based on one or more parameters, such as the same (identical) SSID, an IP address, a media access controller (MAC) address, or any other such identifiers of the communication-client 114.

Further, the communication-server 112 determines whether the duration for which the connection is not open is longer than a predetermined error threshold at block 314. In an example, the communication-server 112 initiates a clock/timer when the connection is detected to be closed (not open). The timer/clock is checked to determine the duration of the connection loss, i.e., glitch. If the duration of the timer/clock is longer than an error threshold, which is a predetermined, configurable value, the computing device 110 displays an error indicating that a communication failure has occurred at block 316. Method 300 terminates so that the operator can diagnose and fix the communication failure. For example, the error threshold can be set to 2 seconds, 3 seconds, 1 minute, or any other such value. The clock/timer is stopped when the connection is re-established, in which case, the value of the clock/timer is shorter than the error threshold value.

If the duration of the glitch is shorter than the error threshold, the communication-server 112 re-establishes one or more communication channels with the communication-client 114 via the re-established connection at block 318. Re-establishing the communication channels can include establishing one or more pipes, sockets, ports, and other such parameters.

The communication-server 112 determines whether the command was submitted to the communication-client 114 earlier, at block 320. In one or more embodiments, a flag/identifier is associated with each command instance that is submitted. By checking if such a flag exists, the communication-server 112 can determine whether a command has been submitted.

If it is determined that the command was submitted earlier, at block 320, the communication-server 112 checks if a response has been generated and sent by the communication-client 114, at block 308. It should be noted that the response may be sent via a separate communication connection, for example, UDP, by the communication-client 114 to the communication-server 112. If the response has been received, the communication is deemed to be successful, and method 300 can be repeated at block 310.

Alternatively, if the communication-server 112 determines that the command was not submitted to the communication-client 114 earlier, at block 320, the communication-server 112 submits the command to the communication-client 114 via the connection that has been re-established, at block 306. If a response to the command is received, at block 308, the communication is deemed to be successful, and the method 300 can be repeated at block 310.

If a response to a submitted command is not received by the communication-server 112, at block 308, the communication-server 112 deems that the connection experienced a glitch after the command was submitted and waits for the connection to be re-established at block 312.

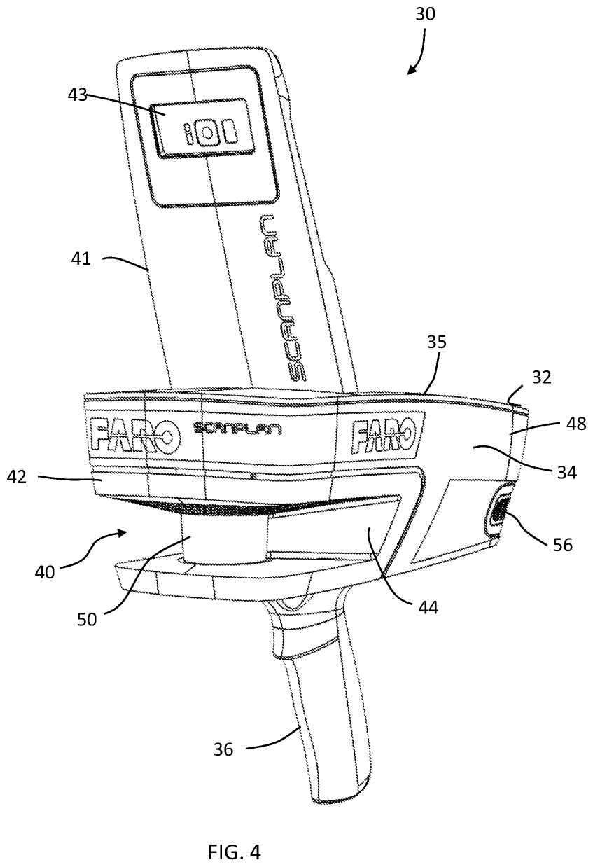

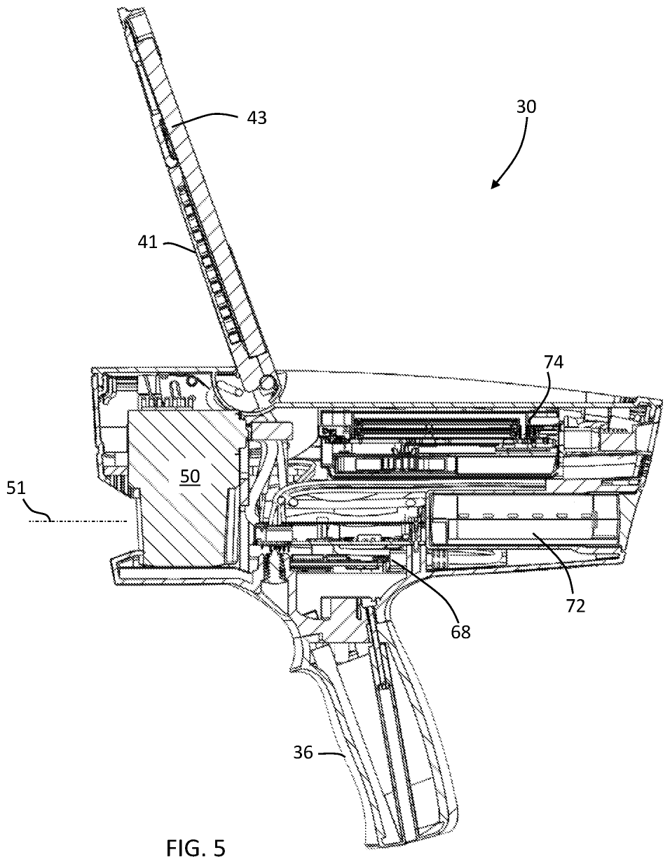

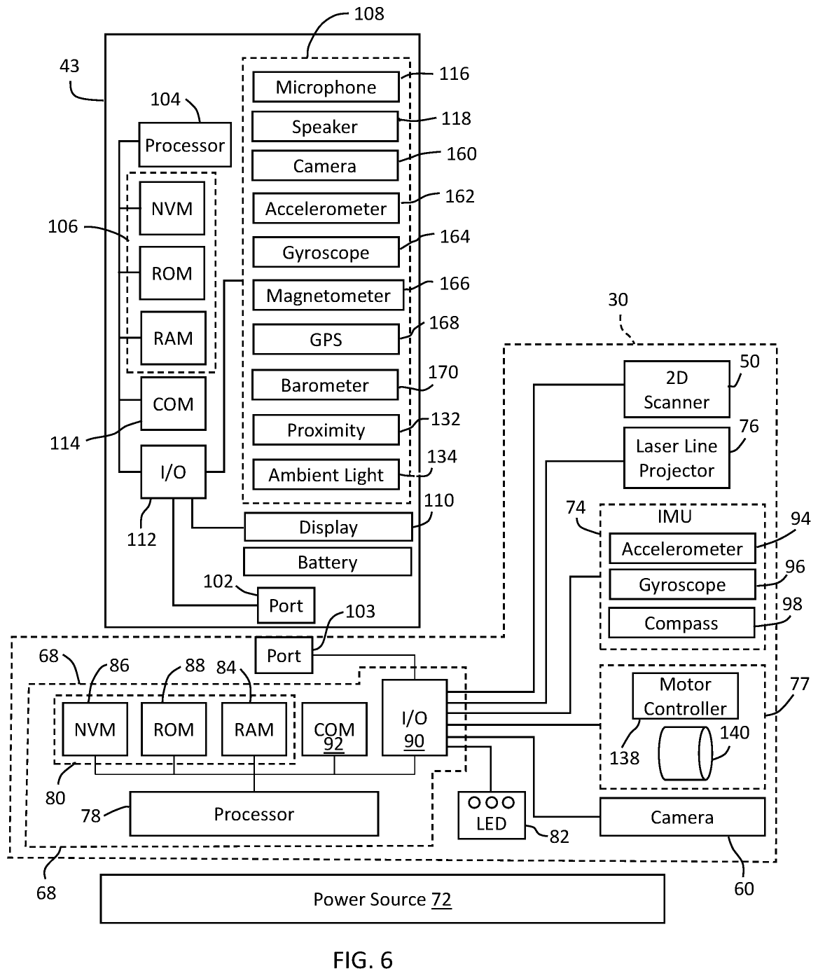

FIG. 4, FIG. 5, and FIG. 6 depict an embodiment of a system 30 having a housing 32 that includes a body portion 34 and a handle portion 36. System 30 can be used as the coordinates-measurement device 120. In an embodiment, the handle 36 may include an actuator 38 that allows the operator to interact with the system 30. In the exemplary embodiment, body 34 includes a generally rectangular center portion 35 with a slot 40 formed in an end 42. Slot 40 is at least partially defined by a pair of walls 44 that are angled towards a second end 48. As will be discussed in more detail herein, a portion of a two-dimensional scanner is arranged between the walls 44. Walls 44 are angled to allow the scanner to operate by emitting light over a large angular area without interference from walls 44. As will be discussed in more detail herein, end 42 may further include a three-dimensional camera or RGBD camera 60.

Extending from the center portion 35 is a mobile device holder 41. The mobile device holder 41 is configured to securely couple a mobile device 43 to the housing 32. The holder 41 may include one or more fastening elements, such as a magnetic or mechanical latching element, for example, that couples the mobile device 43 to the housing 32. In an embodiment, the mobile device 43 is coupled to communicate with a controller 68. The communication between controller 68 and the mobile device 43 may be via any suitable communications medium, such as wired, wireless, or optical communication mediums, for example.

In the illustrated embodiment, holder 41 is pivotally coupled to the housing 32, such that it may be selectively rotated into a closed position within a recess 46. In an embodiment, recess 46 is sized and shaped to receive the holder 41 with the mobile device 43 disposed of therein.

In the exemplary embodiment, the second end 48 includes a plurality of exhaust vent openings 56. In an embodiment, the exhaust vent openings 56 are fluidly coupled to intake vent openings 58 arranged on a bottom surface 62 of center portion 35. The intake vent openings 58 allow external air to enter a conduit 64, having an opposite opening 66 in fluid communication with the hollow interior 67 of the body 34. In an embodiment, the opening 66 is arranged adjacent to a controller 68, which has one or more processors that is operable to perform the methods described herein. In an embodiment, the external air flows from the opening 66 over or around the controller 68 and out the exhaust vent openings 56.

The controller 68 is coupled to a wall 70 of body 34. In an embodiment, wall 70 is coupled to or integral with the handle 36. The controller 68 is electrically coupled to the 2D scanner, the 3D camera 60, a power source 72, an inertial measurement unit (IMU) 74, a laser line projector 76, and a haptic feedback device 77.

Elements are shown of the system 30 with the mobile device 43 installed or coupled to the housing 32. Controller 68 is a suitable electronic device capable of accepting data and instructions, executing the instructions to process the data, and presenting the results. Controller 68 includes one or more processing elements 78. The processors may be microprocessors, field programmable gate arrays (FPGAs), digital signal processors (DSPs), and generally any device capable of performing computing functions. One or more processors 78 have access to memory 80 for storing information.

Controller 68 can convert the analog voltage or current level provided by 2D scanner, camera 60, and IMU 74 into a digital signal to determine a distance from the system 30 to an object in the environment. In an embodiment, the camera 60 is a 3D or RGBD type camera. Controller 68 uses the digital signals that act as input to various processes for controlling the system 30. The digital signals represent one or more system 30 data, including but not limited to distance to an object, images of the environment, acceleration, pitch orientation, yaw orientation, and roll orientation. As will be discussed in more detail, the digital signals may be from components internal to the housing 32 or from sensors and devices located in the mobile device 43.

In general, when mobile device 43 is not installed, controller 68 accepts data from the 2D scanner and IMU 74 and is given certain instructions for the purpose of generating a two-dimensional map of a scanned environment. Controller 68 provides operating signals to the 2D scanner, the camera 60, laser line projector 76, and haptic feedback device 77. Controller 68 also accepts data from IMU 74, indicating, for example, whether the operator is operating in the system in the desired orientation. Controller 68 compares the operational parameters to predetermined variances (e.g., yaw, pitch, or roll thresholds) and, if the predetermined variance is exceeded, generates a signal that activates the haptic feedback device 77. The data received by controller 68 may be displayed on a user interface coupled to controller 68. The user interface may be one or more LEDs (light-emitting diodes) 82, an LCD (liquid-crystal diode) display, a CRT (cathode ray tube) display, or the like. A keypad may also be coupled to the user interface for providing data input to controller 68. In one embodiment, the user interface is arranged or executed on the mobile device 43.

The controller 68 may also be coupled to external computer networks such as a local area network (LAN) and the Internet. A LAN interconnects one or more remote computers, which are configured to communicate with controller 68 using a well-known computer communications protocol such as TCP/IP (Transmission Control Protocol/Internet Protocol), RS-232, ModBus, and the like. Additional systems 30 may also be connected to LAN with the controllers 68 in each of these systems 30 being configured to send and receive data to and from remote computers and other systems 30. The LAN may be connected to the Internet. This connection allows controller 68 to communicate with one or more remote computers connected to the Internet.

The processors 78 are coupled to memory 80. The memory 80 may include random access memory (RAM) device 84, a non-volatile memory (NVM) device 86, a read-only memory (ROM) device 88. In addition, the processors 78 may be connected to one or more input/output (I/O) controllers 90 and a communications circuit 92. In an embodiment, the communications circuit 92 provides an interface that allows wireless or wired communication with one or more external devices or networks, such as the LAN discussed above.

Controller 68 includes operation control methods described herein, which can be embodied in application code. These methods are embodied in computer instructions written to be executed by processors 78, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (Hypertext Markup Language), Python, Ruby, and any combination or derivative of at least one of the foregoing.

Coupled to controller 68 is the 2D scanner. The 2D scanner measures 2D coordinates in a plane. In the exemplary embodiment, the scanning is performed by steering light within a plane to illuminate object points in the environment. The 2D scanner collects the reflected (scattered) light from the object points to determine 2D coordinates of the object points in the 2D plane. In an embodiment, the 2D scanner scans a spot of light over an angle while at the same time measuring an angle value and corresponding distance value to each of the illuminated object points.

Examples of 2D scanners include but are not limited to Model LMS103 scanners manufactured by Sick, Inc of Minneapolis, Minn. and scanner Models URG-04LX-UG01 and UTM-30LX manufactured by Hokuyo Automatic Co., Ltd of Osaka, Japan. The scanners in the Sick LMS103 family measure angles over a 270-degree range and over distances up to 20 meters. The Hoyuko model URG-04LX-UG01 is a low-cost 2D scanner that measures angles over a 240-degree range and distances up to 4 meters. The Hoyuko model UTM-30LX is a 2D scanner that measures angles over a 270-degree range and to distances up to 30 meters. It should be appreciated that the above 2D scanners are exemplary and other types of 2D scanners are also available.

In an embodiment, the 2D scanner is oriented so as to scan a beam of light over a range of angles in a generally horizontal plane (relative to the floor of the environment being scanned). At instants in time, the 2D scanner returns an angle reading and a corresponding distance reading to provide 2D coordinates of object points in the horizontal plane. In completing one scan over the full range of angles, the 2D scanner returns a collection of paired angle and distance readings. As system 30 is moved from place to place, the 2D scanner continues to return 2D coordinate values. These 2D coordinate values are used to locate the position of the system 30, thereby enabling the generation of a two-dimensional map or floorplan of the environment.

Also coupled to controller 68 is the IMU 74. The IMU 74 is a position/orientation sensor that may include accelerometers 94 (inclinometers), gyroscopes 96, a magnetometer or compass 98, and altimeters. In the exemplary embodiment, the IMU 74 includes multiple accelerometers 94 and gyroscopes 96. The compass 98 indicates a heading based on changes in magnetic field direction relative to the earth's magnetic north. The IMU 74 may further have an altimeter that indicates altitude (height). An example of a widely used altimeter is a pressure sensor. By combining readings from a combination of position/orientation sensors with a fusion algorithm that may include a Kalman filter, relatively accurate position and orientation measurements can be obtained using relatively low-cost sensor devices. In the exemplary embodiment, the IMU 74 determines the pose or orientation of the system 30 about three-axis to allow a determination of yaw, roll, and pitch parameter.

System 30 further includes a camera 60 that is a 3D or RGB-D camera. As used herein, the term 3D camera refers to a device that produces a two-dimensional image that includes distances to a point in the environment from the location of system 30. The 3D camera 30 may be a range camera or a stereo camera. In an embodiment, the 3D camera 30 includes an RGB-D sensor that combines color information with per-pixel depth information. In an embodiment, the 3D camera 30 may include an infrared laser projector 31, a left infrared camera 33, a right infrared camera 39, and a color camera 37. In an embodiment, the 3D camera 60 is a RealSense™ camera model R200 manufactured by Intel Corporation. In still another embodiment, the 3D camera 30 is a RealSense™ LIDAR camera model L515 manufactured by Intel Corporation.

In an embodiment, when the mobile device 43 is coupled to the housing 32, the mobile device 43 becomes an integral part of the system 30. In an embodiment, the mobile device 43 is a cellular phone, a tablet computer, or a personal digital assistant (PDA). The mobile device 43 may be coupled for communication via a wired connection, such as ports 103, 102. Port 103 is coupled for communication to the processor 78, such as via I/O controller 90, for example. Ports 103, 102 may be any suitable port, such as but not limited to USB, USB-A, USB-B, USB-C, IEEE 1394 (Firewire), or Lightning™ connectors.

The mobile device 43 is a suitable electronic device capable of accepting data and instructions, executing the instructions to process the data, and presenting the results. The mobile device 43 includes one or more processing elements 104. The processors may be microprocessors, field programmable gate arrays (FPGAs), digital signal processors (DSPs), and generally any device capable of performing computing functions. One or more processors 104 have access to memory 106 for storing information.

The mobile device 43 can convert the analog voltage or current level provided by sensors 108 and processor 78. Mobile device 43 uses the digital signals that act as input to various processes for controlling the system 30. The digital signals represent one or more system 30 data, including but not limited to distance to an object, images of the environment, acceleration, pitch orientation, yaw orientation, roll orientation, global position, ambient light levels, and altitude, for example.

In general, mobile device 43 accepts data from sensors 108 and is given certain instructions for the purpose of generating or assisting the processor 78 in the generation of a two-dimensional map or three-dimensional map of a scanned environment. Mobile device 43 provides operating signals to the processor 78, the sensors 108, and a display 110. Mobile device 43 also accepts data from sensors 108, indicating, for example, to track the position of the mobile device 43 in the environment or measure coordinates of points on surfaces in the environment. Mobile device 43 compares the operational parameters to predetermined variances (e.g., yaw, pitch, or roll thresholds) and, if the predetermined variance is exceeded, may generate a signal. The data received by the mobile device 43 may be displayed on display 110. In an embodiment, the display 110 is a touch screen device that allows the operator to input data or control the operation of the system 30.

Controller 68 may also be coupled to external networks such as a local area network (LAN), a cellular network, and the Internet. A LAN interconnects one or more remote computers, which are configured to communicate with controller 68 using a well-known computer communications protocol such as TCP/IP (Transmission Control Protocol/Internet Protocol), RS-232, ModBus, and the like. Additional systems 30 may also be connected to LAN with the controllers 68 in each of these systems 30 being configured to send and receive data to and from remote computers and other systems 30. The LAN may be connected to the Internet. This connection allows controller 68 to communicate with one or more remote computers connected to the Internet.

The processors 104 are coupled to memory 106. The memory 106 may include random access memory (RAM) device, a non-volatile memory (NVM) device, and a read-only memory (ROM) device. In addition, the processors 104 may be connected to one or more input/output (I/O) controllers 112 and a communications circuit 114. In an embodiment, the communications circuit 114 provides an interface that allows wireless or wired communication with one or more external devices or networks, such as the LAN or the cellular network discussed above.

Processor 104 includes operation control methods described herein, which can be embodied in application code. These methods are embodied in computer instructions written to be executed by processors 78, 104, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (Hypertext Markup Language), Python, Ruby and any combination or derivative of at least one of the foregoing.

Also coupled to the processor 104 are the sensors 108. The sensors 108 may include but are not limited to: a microphone 116; a speaker 118; a front or rear facing camera 160; accelerometers 162 (inclinometers), gyroscopes 164, a magnetometers or compass 126; a global positioning satellite (GPS) module 168; a barometer 170; a proximity sensor 132; and an ambient light sensor 134. By combining readings from a combination of sensors 108 with a fusion algorithm that may include a Kalman filter, relatively accurate position and orientation measurements can be obtained.

It should be appreciated that the sensors 60, 74 integrated into the scanner 30 may have different characteristics than the sensors 108 of mobile device 43. For example, the resolution of the cameras 60, 160 may be different, or the accelerometers 94, 162 may have different dynamic ranges, frequency response, sensitivity (mV/g), or temperature parameters (sensitivity or range). Similarly, the gyroscopes 96, 164, or compass/magnetometer may have different characteristics. It is anticipated that in some embodiments, one or more sensors 108 in the mobile device 43 may be of higher accuracy than the corresponding sensors 74 in the system 30. As described in more detail herein, in some embodiments, the processor 78 determines the characteristics of each of the sensors 108 and compares them with the corresponding sensors in the system 30 when the mobile device. The processor 78 then selects which sensors, 74, 108, are used during operation. In some embodiments, the mobile device 43 may have additional sensors (e.g., microphone 116, camera 160) that may be used to enhance operation compared to the operation of the system 30 without the mobile device 43. In still further embodiments, system 30 does not include the IMU 74, and processor 78 uses the sensors 108 for tracking the position and orientation/pose of the system 30. In still further embodiments, the addition of the mobile device 43 allows the system 30 to utilize the camera 160 to perform three-dimensional (3D) measurements either directly (using an RGB-D camera) or using photogrammetry techniques to generate 3D maps. In an embodiment, processor 78 uses the communications circuit (e.g., a cellular 4G internet connection) to transmit and receive data from remote computers or devices.

In the exemplary embodiment, system 30 is a handheld portable device that is sized and weighted to be carried by a single person during operation. Therefore, plane 136, in which the 2D scanner projects a light beam, may not be horizontal relative to the floor or may continuously change as the computer moves during the scanning process. Thus, the signals generated by the accelerometers 94, gyroscopes 96, and compass 98 (or the corresponding sensors 108) may be used to determine the pose (yaw, roll, tilt) of the system 30 and determine the orientation of the plane 51.

In an embodiment, it may be desired to maintain the pose of the system 30 (and thus the plane 136) within predetermined thresholds relative to the yaw, roll, and pitch orientations of the system 30. In an embodiment, a haptic feedback device 77 is disposed of within the housing 32, such as in the handle 36. The haptic feedback device 77 is a device that creates a force, vibration, or motion that is felt or heard by the operator. The haptic feedback device 77 may be but is not limited to: an eccentric rotating mass vibration motor or a linear resonant actuator, for example. The haptic feedback device is used to alert the operator that the orientation of the light beam from the 2D scanner is equal to or beyond a predetermined threshold. In operation, when the IMU 74 measures an angle (yaw, roll, pitch, or a combination thereof), the controller 68 transmits a signal to a motor controller 138 that activates a vibration motor 140. Since the vibration originates in handle 36, the operator will be notified of the deviation in the orientation of the system 30. The vibration continues until system 30 is oriented within the predetermined threshold, or the operator releases the actuator 38. In an embodiment, it is desired for the plane 136 to be within 10-15 degrees of horizontal (relative to the ground) about the yaw, roll, and pitch axes.

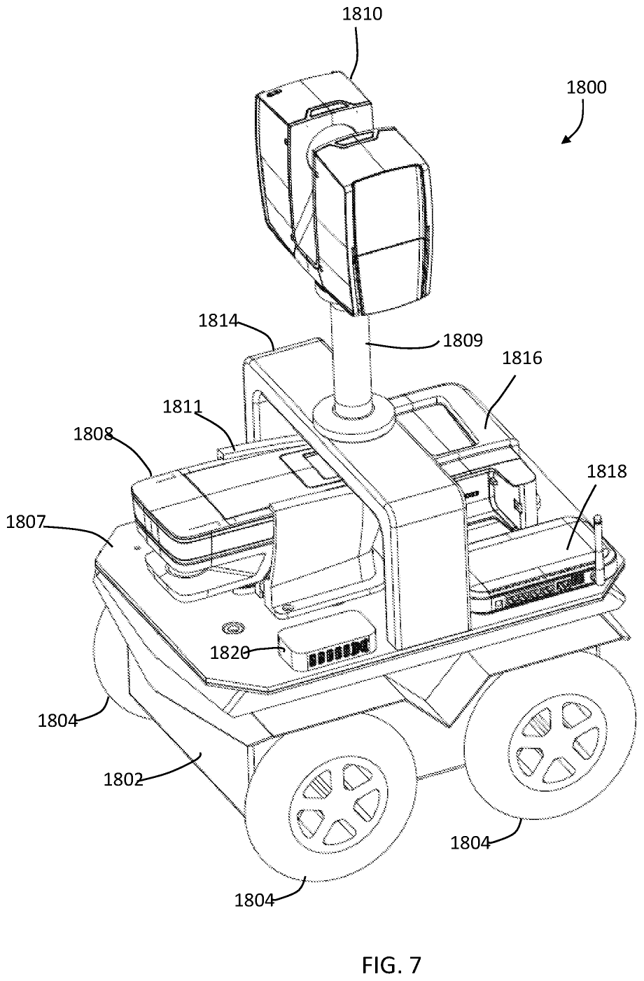

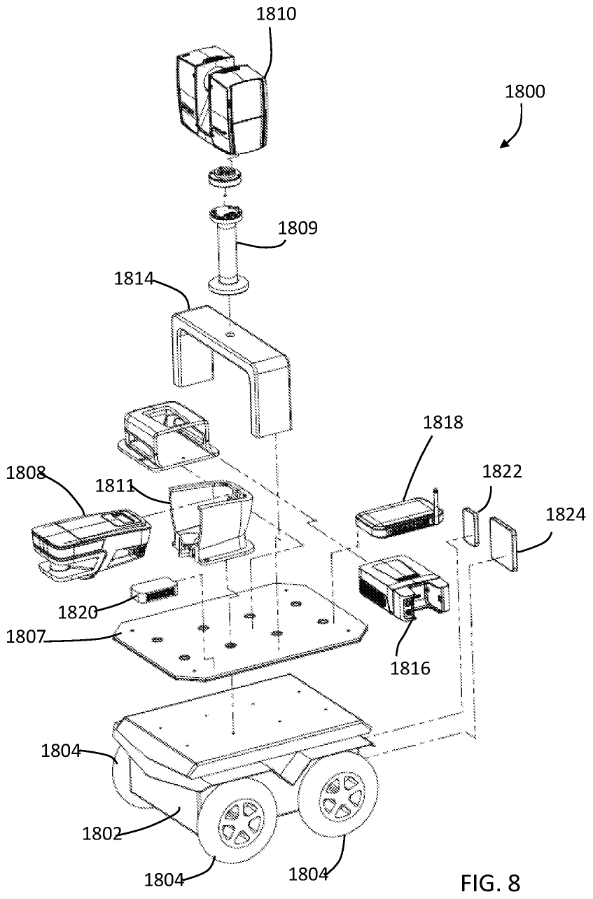

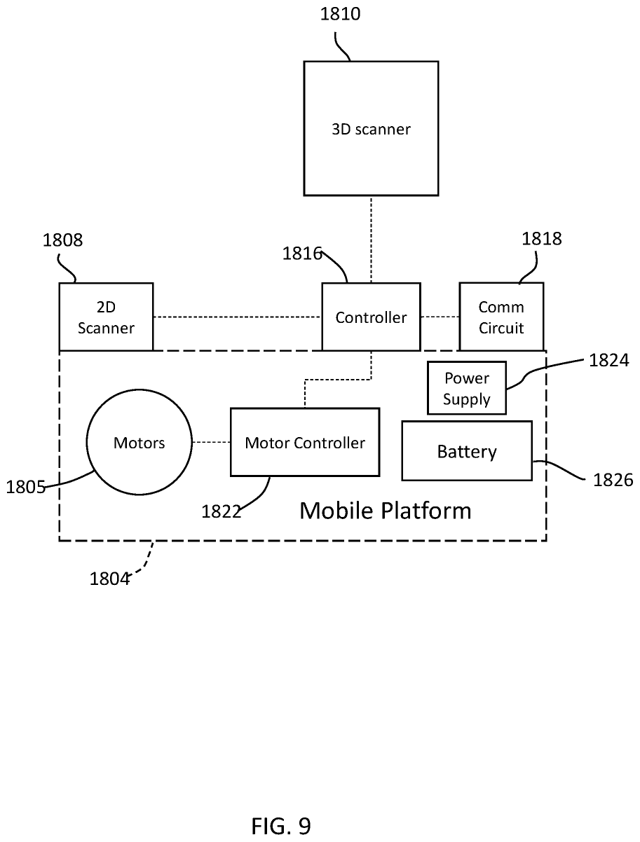

Referring now to FIG. 7, FIG. 19, and FIG. 9, an embodiment is shown of a mobile scanning platform 1800. The mobile scanning platform 1800 can be used as the scanner 120. The mobile scanning platform 1800 includes a base unit 1802 having a plurality of wheels 1804. The wheels 1804 are rotated by motors 1805. In an embodiment, an adapter plate 1807 is coupled to the base unit 1802 to allow components and modules to be coupled to the base unit 1802. The mobile scanning platform 1800 further includes a 2D scanner 1808 and a 3D scanner 1810. In the illustrated embodiment, each scanner 1808, 1810 is removably coupled to the adapter plate 1806. The 2D scanner 1808 may be the scanner illustrated and described herein. As will be described in more detail herein, in some embodiments, the 2D scanner 1808 is removable from the adapter plate 1806 and is used to generate a map of the environment, plan a path for the mobile scanning platform to follow, and define 3D scanning locations. In the illustrated embodiment, the 2D scanner 1808 is slidably coupled to a bracket 1811 that couples the 2D scanner 1808 to the adapter plate 1807.

In an embodiment, the 3D scanner 1810 is a time-of-flight (TOF) laser scanner such as that shown and described herein. The scanner 1810 may be that described in commonly owned U.S. Pat. No. 8,705,012, which is incorporated by reference herein. In an embodiment, the 3D scanner 1810 is mounted on a pedestal or post 1809 that elevates the 3D scanner 1810 above (e.g., further from the floor than) the other components in the mobile scanning platform 1800 so that the emission and receipt of the light beam are not interfered with. In the illustrated embodiment, the pedestal 1809 is coupled to the adapter plate 1807 by a u-shaped frame 1814.

In an embodiment, the mobile scanning platform 1800 further includes a controller 1816. The controller 1816 is a computing device having one or more processors and memory. The one or more processors are responsive to non-transitory executable computer instructions for performing operational methods such as those described herein. The processors may be microprocessors, field programmable gate arrays (FPGAs), digital signal processors (DSPs), and generally any device capable of performing computing functions. One or more processors have access to memory for storing information.

Coupled for communication to the controller 1816 is a communications circuit 1818 and an input/output hub 1820. In the illustrated embodiment, the communications circuit 1818 is configured to transmit and receive data via a wireless radio-frequency communications medium, such as WIFI or Bluetooth, for example. In an embodiment, the 2D scanner 1808 communicates with the controller 1816 via the communications circuit 1818

In an embodiment, the mobile scanning platform 1800 further includes a motor controller 1822 that is operably coupled to the control the motors 1805. In an embodiment, the motor controller 1822 is mounted to an external surface of the base unit 1802. In another embodiment, the motor controller 1822 is arranged internally within the base unit 1802. The mobile scanning platform 1800 further includes a power supply 1824 that controls the flow of electrical power from a power source, such as batteries 1826, for example. The batteries 1826 may be disposed of within the interior of the base unit 1802. In an embodiment, the base unit 1802 includes a port (not shown) for coupling the power supply to an external power source for recharging the batteries 1826. In another embodiment, the batteries 1826 are removable or replaceable.

Referring now to FIGS. 11-13, an embodiment of the laser tracker device 22A will be described. In some embodiments, one or more of the laser tracker devices 22A-22E may be constructed in a manner similar to those described in commonly owned U.S. Pat. Nos. 8,558,992, 8,537,376, 8,724,120, and 7,583,375, the contents of which are incorporated by reference herein. In an embodiment, the laser tracker device 22A includes an optional auxiliary unit processor 1134 and an optional auxiliary computer 1136. In an embodiment, one or both of the auxiliary unit processor 1134 or the auxiliary computer 1136 may be a node, such as node 28, for example, on the computer network 26. An exemplary gimbaled beam-steering mechanism 38 of laser tracker device 22A comprises a zenith carriage 1140 mounted on an azimuth base 1142 and rotated about an azimuth axis 1144. A payload 1146 is mounted on the zenith carriage 1140 and rotated about a zenith axis 1148. Zenith axis 1148 and azimuth axis 1144 intersect orthogonally, internally to laser tracker device 22A, at gimbal point 1150, which is typically the origin for distance measurements. A light beam 1152 virtually passes through the gimbal point 1150 and is pointed orthogonal to zenith axis 1148. In other words, laser beam 1152 lies in a plane approximately perpendicular to the zenith axis 1148 and that passes through the azimuth axis 1144. The outgoing laser beam 1152 is pointed in the desired direction by rotation of payload 1146 about zenith axis 1148 and by rotation of zenith carriage 1140 about azimuth axis 1144.

In an embodiment, the payload 1146 is rotated about the azimuth axis 1144 and zenith axis 1148 by motors 1154, 1156 respectively. The motors 1154, 1156 may be located internal to the laser tracker device 22A and are aligned with the mechanical axes 1144, 1148. A zenith angular encoder, internal to the laser tracker device 22A, is attached to a zenith mechanical axis aligned to the zenith axis 1148. An azimuth angular encoder, internal to the tracker, is attached to an azimuth mechanical axis aligned to the azimuth axis 1144. The zenith and azimuth angular encoders measure the zenith and azimuth angles of rotation to relatively high accuracy. Outgoing laser beam 1152 travels to a retroreflector target, such as retroreflective target 24A, for example. In an embodiment, the retroreflective target may be a spherically mounted retroreflector (SMR), for example. By measuring the radial distance between gimbal point 1150 and retroreflective target 24A, the rotation angle about the zenith axis 1148, and the rotation angle about the azimuth axis 1144, the position of retroreflective target 24A may be found within the spherical coordinate system of the laser tracker device 22A.

Outgoing light beam 1152 may include one or more wavelengths. For the sake of clarity and simplicity, a steering mechanism of the sort shown in FIG. 11 is assumed in the following discussion. However, other types of steering mechanisms are possible. For example, it is possible to reflect a laser beam off a mirror rotated about the azimuth and zenith axes. The techniques described herein are applicable, regardless of the type of steering mechanism.

Magnetic nests 1158 may be included on the laser tracker for resetting the laser tracker to a “home” position for different sized SMRs—for example, 1.5, ⅞, and ½ inch SMRs. In addition, an on-tracker mirror, not visible from the view of FIG. 11, may be used in combination with the on-tracker retroreflector to enable the performance of a self-compensation.

As will be discussed in more detail herein, one or more target cameras 1160 may be disposed on the payload 1146 adjacent to the aperture 1162 from which the light beam 1152 is emitted. In an embodiment, the cameras 1160 enable the user to view the environment in the direction of the laser tracker device 22A via the display on the mobile computing device 30. In an embodiment, the laser tracker device 22A may also have one or more light sources 1164 located on the payload 1146 adjacent to the cameras 1160. As will be discussed in more detail herein, the light sources 1164 may be selectively activated on a periodic or aperiodic basis to emit light into the environment to assist in the identification of retroreflective targets 24A-24D.

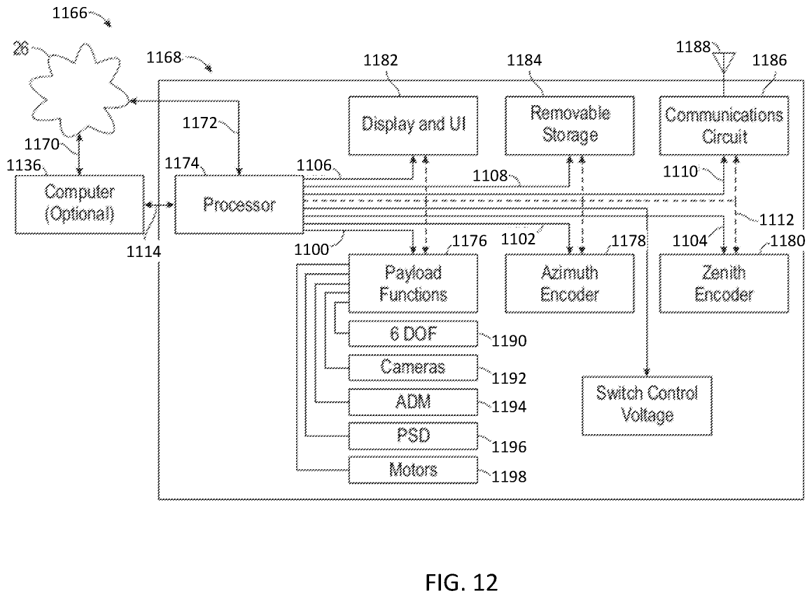

FIG. 12 is a block diagram depicting a dimensional measurement electronics processing system 1166 that includes a laser tracker electronics processing system 1168 and computer 1136. The processing system 1168 may be connected to the computer network 26 via computer 1136 and communications medium 1170 or directly via a communications medium 1172. Exemplary laser tracker electronics processing system 1168 includes one or more processors 1174, payload functions electronics 1176, azimuth encoder electronics 1178, zenith encoder electronics 1180, display and user interface (UI) electronics 1182, removable storage hardware 1184, communications circuit 1186 electronics, and in an embodiment an antenna 1188. The payload functions electronics 1176 includes a number of subfunctions, including the six-DOF electronics 1190, the camera electronics 1192, the absolute distance meter (ADM) electronics 1194, the position detector (PSD) electronics 1196, and motor controller electronics 1198. Most of the subfunctions have at least one processor unit, which might be a digital signal processor (DSP) or field programmable gate array (FPGA), for example. In an embodiment, the payload functions 1176 are located in the payload 1146. In some embodiments, the azimuth encoder electronics 1178 are located in the azimuth assembly, and the zenith encoder electronics 1180 are located in the zenith assembly.

As used herein, when a reference is made to one or more processors of the laser tracker device 22A, it is meant to include possible external computer and cloud support.

In an embodiment, a separate communications bus goes from the processor 1174 to each of the electronics units 1176, 1178, 1180, 1182, 1184, and 1186. Each communications line may have, for example, three serial lines that include the data line, clock line, and frame line. The frame line indicates whether or not the electronics unit should pay attention to the clock line. If it indicates that attention should be given, the electronics unit reads the current value of the data line at each clock signal. The clock-signal may correspond, for example, to a rising edge of a clock pulse. In an embodiment, information is transmitted over the data line in the form of a packet. In an embodiment, each packet includes an address, a numeric value, a data message, and a checksum. The address indicates where, within the electronics unit, the data message is to be directed. The location may, for example, correspond to a processor subroutine within the electronics unit. The numeric value indicates the length of the data message. The data message contains data or instructions for the electronics unit to carry out. The checksum is a numeric value that is used to minimize the chance that errors are transmitted over the communications line.

In an embodiment, the processor 1174 sends packets of information over bus 1100 to payload functions electronics 1176, over bus 1102 to azimuth encoder electronics 1178, over bus 1104 to zenith encoder electronics 1180, over bus 1106 to display, and UI electronics 1182, over bus 1108 to removable storage hardware 1184, and over bus 1110 to communications circuit 1186.

In an embodiment, processor 1174 also sends a synch (synchronization) pulse over the synch bus 1112 to each of the electronics units at the same time. The synch pulse provides a way of synchronizing values collected by the measurement functions of the laser tracker. For example, the azimuth encoder electronics 1178 and the zenith electronics 1180 latch their encoder values as soon as the synch pulse is received. Similarly, the payload functions electronics 1176 latch the data collected by the electronics contained within the payload. The six-DOF, ADM, and position detector all latch data when the synch pulse is given. In most cases, the camera and inclinometer collect data at a slower rate than the synch pulse rate but may latch data at multiples of the synch pulse period.

In an embodiment, the azimuth encoder electronics 1178 and zenith encoder electronics 1180 are separated from one another and from the payload functions 1176 by slip rings, which are electromechanical devices that allow the transmission of electrical power and electrical signals from a stationary to a rotating structure, and vice versa. For this reason, the bus lines 1100, 1102, and 1104 are depicted as separate bus lines.

The laser tracker electronics processing system 1168 may communicate with an external computer 1136, or it may provide computation, display, and UI functions within the laser tracker. The laser tracker communicates with computer 1136 over communications link 114, which might be, for example, an Ethernet line or a wireless connection. The laser tracker may also communicate with other elements such as node 28, via computer network 26, through communications medium 1172, which might include one or more electrical cables, such as Ethernet cables, and one or more wireless connections. It should be appreciated that while FIG. 12 illustrates the communications medium 1172 as extending from the computer network 26 directly to the processor 1174, in some embodiments, signals may be transmitted and received via the communications circuit 1186. As discussed in more detail herein, a user having the mobile computing device 30 may have a connection to the computer network 26 over an Ethernet or wireless communications medium, which in turn connects to the processor 1174 over an Ethernet or wireless communications medium. In this way, a user may control the functions of a remote laser tracker.

In an embodiment, a laser tracker may use one visible wavelength (usually red) and one infrared wavelength for the ADM. The red wavelength may be provided by a frequency stabilized helium-neon (HeNe) laser suitable for use in an interferometer and also for use in providing a red pointer beam. In other embodiments, the red wavelength may be provided by a diode laser that serves just as a pointer beam. In another embodiment, a laser tracker uses a single visible wavelength (for example, red) for both the ADM and the pointer beam.

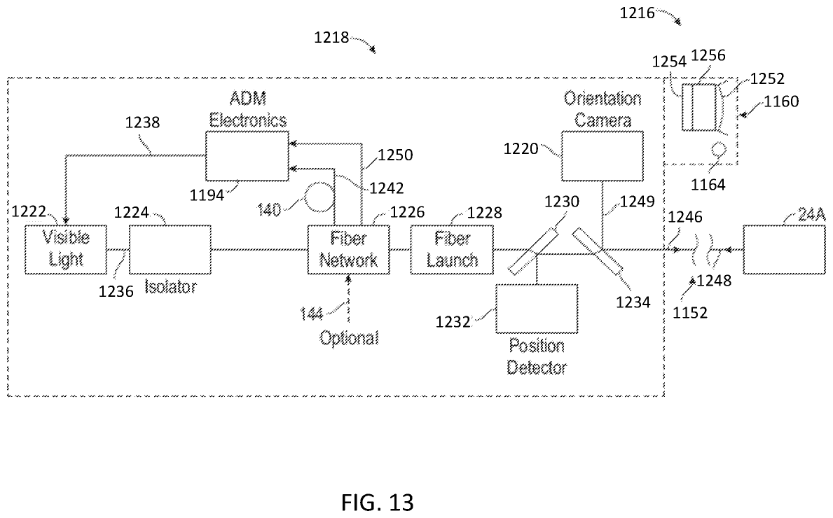

FIG. 13 shows an embodiment of a laser tracker device having a target camera system 1116 and an optoelectronic system 1118 in which an optional orientation camera 1220 is combined with the optoelectronic functionality of a 3D laser tracker to measure the distance to the retroreflective target 24A. In an embodiment, the optoelectronic system 1118 includes a visible light source 1222, an isolator 1224, ADM electronics 1194, a fiber network 1226, a fiber launch 1228, a beam splitter 1230, a position detector 1232, a beam splitter 1234, and an optional orientation camera 1220. The light from the visible light source 1222 is emitted in optical fiber 1236 and travels through isolator 1224, which may have optical fibers coupled on the input and output ports. The ADM electronics 1194 sends an electrical signal over connection 1238 to modulate the visible light source 1222. Some of the light entering the fiber network travels through the fiber length equalizer 1240 and the optical fiber 1242 to enter the reference channel of the ADM electronics 1194. An electrical signal 1244 may optionally be applied to the fiber network 1226 to provide a switching signal to a fiber optic switch within the fiber network 1226. A part of the light travels from the fiber network to the fiber launch 1228, which sends the light on the optical fiber into free space as light beam 1246. A small amount of the light reflects off the beam splitter 1230 and is lost. A portion of the light passes through the beam splitter 1230, through the beam splitter 1234, and travels out of the tracker to retroreflective target 24A.

On its return path, the light 1248 from the retroreflective target 24A enters the optoelectronic system 1118 and arrives at beam splitter 1234. Part of the light is reflected off the beam splitter 1234 and enters the optional orientation camera 1220. The optional orientation camera 1220 records an image of the light 1249, which is evaluated by a processor to determine three orientational degrees-of-freedom of the retroreflector target 24A. A portion of the light at beam splitter 1230 travels through the beam splitter and is put onto an optical fiber by the fiber launch 1228. The light travels to fiber network 1226. Part of this light travels to optical fiber 1250, from which it enters the measured channel of the ADM electronics 1194.

The target camera system 1116 includes one or more cameras 1160, each having one or more light sources 1164. The target camera system 1116 is also shown in FIG. 11. The camera 1160 includes a lens system 1252, a photosensitive array 1254, and a body 1256. One use of the target camera system 1116 is to locate retroreflector targets in the work volume. In an embodiment, each target camera does this by flashing the light source 1164, which the camera 1160 picks up as a bright spot on the photosensitive array 1254. As will be discussed in more detail herein, system 20 is configured to determine and identify retroreflective targets based on the light from light source 1164. System 20 is further configured to evaluate the images captured by the cameras 1160 to distinguish light reflected by the retroreflective targets from other sources of light. Further, the image acquired by camera 1160 may also be transmitted to the mobile computing device where the user may interact with the laser tracker device, such as by reorienting the position of the payload using the image. It should be appreciated that while embodiments herein may refer to “an image,” this is for exemplary purposes, and the claims should not be so narrowly construed as to require a single image. In some embodiments, the camera 1160 acquires a video image (e.g., 30 frames per second).

It should be appreciated that the optoelectronic system 1118 illustrated in FIG. 13 is exemplary and not intended to be limiting. In other embodiments, the optoelectronic system may include additional or fewer components. For example, in some embodiments, the optoelectronic system may include an interferometer for example. The interferometer may be in place of the ADM 1194 or used in combination with the ADM 1194. In other embodiments, the optoelectronic system 1118 may not include the orientation camera 1220.

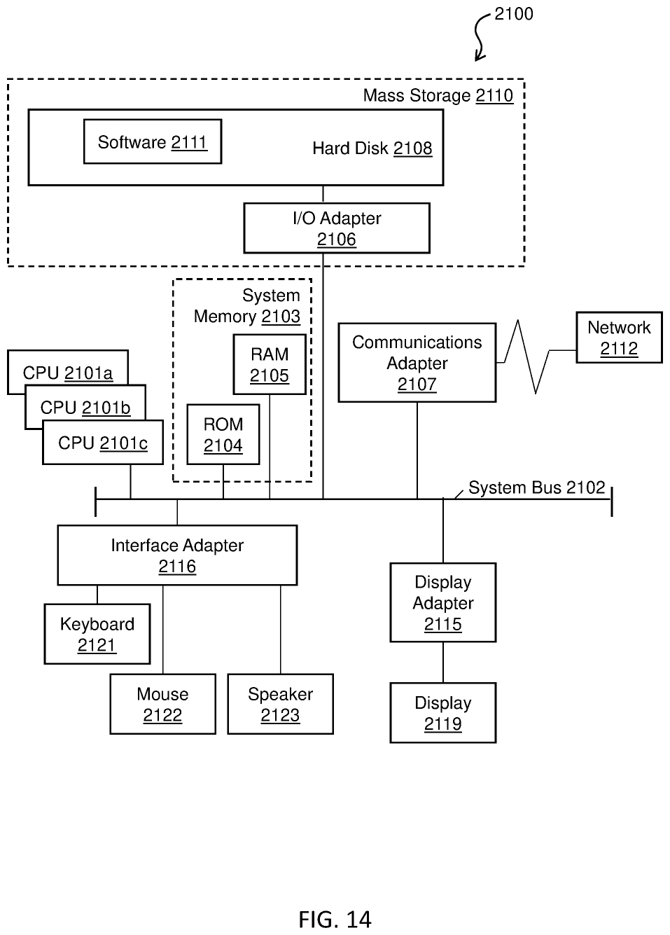

Turning now to FIG. 14, a computer system 2100 is generally shown in accordance with an embodiment. The computer system 2100 can be an electronic computer framework comprising and/or employing any number and combination of computing devices and networks utilizing various communication technologies, as described herein. The computer system 2100 can be easily scalable, extensible, and modular, with the ability to change to different services or reconfigure some features independently of others. The computer system 2100 may be, for example, a server, desktop computer, laptop computer, tablet computer, or smartphone. In some examples, computer system 2100 may be a cloud computing node. Computer system 2100 may be described in the general context of computer system executable instructions, such as program modules, being executed by a computer system. Generally, program modules may include routines, programs, objects, components, logic, data structures, and so on that perform particular tasks or implement particular abstract data types. Computer system 2100 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 14, the computer system 2100 has one or more central processing units (CPU(s)) 2101a, 2101b, 2101c, etc. (collectively or generically referred to as processor(s) 2101). The processors 2101 can be a single-core processor, multi-core processor, computing cluster, or any number of other configurations. The processors 2101, also referred to as processing circuits, are coupled via a system bus 2102 to a system memory 2103 and various other components. The system memory 2103 can include a read only memory (ROM) 2104 and random access memory (RAM) 2105. The ROM 2104 is coupled to the system bus 2102 and may include a basic input/output system (BIOS), which controls certain basic functions of the computer system 2100. The RAM is read-write memory coupled to the system bus 2102 for use by the processors 2101. The system memory 2103 provides temporary memory space for operations of said instructions during operation. The system memory 2103 can include random access memory (RAM), read only memory, flash memory, or any other suitable memory systems.

The computer system 2100 comprises an input/output (I/O) adapter 2106 and a communications adapter 2107 coupled to the system bus 2102. The I/O adapter 2106 may be a small computer system interface (SCSI) adapter that communicates with a hard disk 2108 and/or any other similar component. The I/O adapter 2106 and the hard disk 2108 are collectively referred to herein as mass storage 2110.

Software 2111 for execution on the computer system 2100 may be stored in the mass storage 2110. The mass storage 2110 is an example of a tangible storage medium readable by the processors 2101, where the software 2111 is stored as instructions for execution by the processors 2101 to cause the computer system 2100 to operate, such as is described hereinbelow with respect to the various Figures. Examples of computer program product and the execution of such instruction is discussed herein in more detail. The communications adapter 2107 interconnects the system bus 2102 with a network 2112, which may be an outside network, enabling the computer system 2100 to communicate with other such systems. In one embodiment, a portion of the system memory 2103 and the mass storage 2110 collectively store an operating system, which may be any appropriate operating system to coordinate the functions of the various components shown in FIG. 14.

Additional input/output devices are shown as connected to the system bus 2102 via a display adapter 2115 and an interface adapter 2116 and. In one embodiment, the adapters 2106, 2107, 2115, and 2116 may be connected to one or more I/O buses that are connected to the system bus 2102 via an intermediate bus bridge (not shown). A display 2119 (e.g., a screen or a display monitor) is connected to the system bus 2102 by a display adapter 2115, which may include a graphics controller to improve the performance of graphics-intensive applications and a video controller. A keyboard 2121, a mouse 2122, a speaker 2123, etc., can be interconnected to the system bus 2102 via the interface adapter 2116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 14, the computer system 2100 includes processing capability in the form of the processors 2101, and storage capability including the system memory 2103 and the mass storage 2110, input means such as the keyboard 2121 and the mouse 2122, and output capability including the speaker 2123 and the display 2119.

In some embodiments, the communications adapter 2107 can transmit data using any suitable interface or protocol, such as the internet small computer system interface, among others. The network 2112 may be a cellular network, a radio network, a wide area network (WAN), a local area network (LAN), or the Internet, among others. An external computing device may connect to the computer system 2100 through network 2112. In some examples, an external computing device may be an external web server or a cloud computing node.

It is to be understood that the block diagram of FIG. 14 is not intended to indicate that the computer system 2100 is to include all of the components shown in FIG. 14. Rather, the computer system 2100 can include any appropriate fewer or additional components not illustrated in FIG. 14 (e.g., additional memory components, embedded controllers, modules, additional network interfaces, etc.). Further, the embodiments described herein with respect to computer system 2100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

It should be noted that embodiments of the technical solutions described herein address technical challenges with a coordinate measurement device such as a laser tracker, a scanner, etc., and particularly a coordinate measurement device that communicates with a computing system in real-time to transfer commands and/or data, and wherein a user interface that identifies and facilitates addressing a communication failure between the coordinate measurement device and the computing system is not physically accessible by an operator of the coordinate measurement device. Embodiments described herein detect such a communication failure, which is referred to as a “glitch” and facilitate re-establishing the connection without any operator interaction. It should be noted that although communication failures are more common with wireless connections, wired connections can also experience such communication failures. Embodiments of the technical solutions described herein address the communication failures in case of both wireless, and wired connections.

It will be appreciated that aspects of the present disclosure may be embodied as a system, method, or computer program product and may take the form of a hardware embodiment, a software embodiment (including firmware, resident software, micro-code, etc.), or a combination thereof. Furthermore, aspects of the present disclosure may take the form of a computer program product embodied in one or more computer-readable medium(s) having computer-readable program code embodied thereon.

One or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer-readable storage medium may be a tangible medium containing or storing a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium, and that can communicate, propagate, or transport a program for use by or in connection with an instruction execution system, apparatus, or device.

The computer-readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present disclosure are described herein with reference to flowchart illustrations and/or block diagrams of methods, apparatus (systems) and computer program products according to embodiments. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Terms such as processor, controller, computer, DSP, FPGA are understood in this document to mean a computing device that may be located within an instrument, distributed in multiple elements throughout an instrument, or placed external to an instrument.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope. Additionally, while various embodiments have been described, it is to be understood that aspects may include only some of the described embodiments. Accordingly, the invention is not to be seen as limited by the foregoing description but is only limited by the scope of the appended claims.

What is claimed is:

1. A system comprising:
a coordinate measurement device configured to capture coordinate data; and
a computing device communicatively coupled with the coordinate measurement device, wherein the computing device is configured to:
establish a first communication connection with the coordinate measurement device for submitting one or more commands to the coordinate measurement device;
establish a second communication connection with the coordinate measurement device for receiving scanned data from the coordinate measurement device;
in response to receiving a command for the coordinate measurement device:
determine that the first communication connection is not open;
wait for the first communication connection to re-establish;
in response to the wait for re-establishing the first communication connection being less than a predetermined duration:
re-establish one or more channels for the first communication connection.

2. The system of claim 1, wherein the first communication connection uses connection-based communication protocol.

3. The system of claim 1, wherein the second communication connection uses broadcast-based communication protocol.

4. The system of claim 1, wherein the computing device is further configured to check for a response to the command, in case the command was submitted to the coordinate measurement device prior to a glitch in the first communication connection.

5. The system of claim 4, wherein the computing device is further configured to submit the command to the coordinate measurement device via the re-established first communication connection, in case the command was not submitted to the coordinate measurement device prior to a glitch in the first communication connection.

6. The system of claim 1, wherein the computing device is further configured to notify an operator of a communication failure in response to the wait for re-establishing the first communication connection being more than the predetermined duration.

7. The system of claim 1, wherein the computing device establishes the first communication connection with the coordinate measurement device using a service set identifier broadcast by the coordinate measurement device.

8. A computer-implemented method for detecting a communication connection loss and re-establishing communication connection between a coordinate measurement device and a computing device, the computer-implemented method comprising:
establishing a first communication connection between the computing device and the coordinate measurement device for submitting, by the computing device, one or more commands to the coordinate measurement device;
establishing a second communication connection between the computing device and the coordinate measurement device for receiving, by the computing device, coordinate data from the coordinate measurement device;
in response to receiving, by the computing device, a command for the coordinate measurement device:
determining that the first communication connection is not open;
waiting for the first communication connection to re-establish;
in response to a wait for re-establishing the first communication connection being less than a predetermined duration:
re-establishing, by the computing device, one or more channels for the first communication connection.

9. The computer-implemented method of claim 8, wherein the first communication connection uses connection-based communication protocol.

10. The computer-implemented method of claim 8, wherein the second communication connection uses broadcast-based communication protocol.

11. The computer-implemented method of claim 8, further comprising, checking, by the computing device, for a response to the command, in case the command was submitted to the coordinate measurement device prior to a glitch in the first communication connection.

12. The computer-implemented method of claim 11, further comprising submitting, by the computing device, the command to the coordinate measurement device via the re-established first communication connection, in case the command was not submitted to the coordinate measurement device prior to a glitch in the first communication connection.

13. The computer-implemented method of claim 8, further comprising notifying, by the computing device, an operator of a communication failure in response to the wait for re-establishing the first communication connection being more than the predetermined duration.

14. The computer-implemented method of claim 8, further comprising establishing, by the computing device, the first communication connection with the coordinate measurement device using a service set identifier broadcast by the coordinate measurement device.

15. A system comprising:
a memory; and
one or more processors coupled with the memory, and communicatively coupled with a coordinate measurement device that is configured to capture coordinate data,
wherein the one or more processors are configured to:
establish a first communication connection with the coordinate measurement device for submitting one or more commands to the coordinate measurement device;
establish a second communication connection with the coordinate measurement device for receiving scanned data from the coordinate measurement device;
in response to receiving a command for the coordinate measurement device:
determine that the first communication connection is not open;
wait for the first communication connection to re-establish;
in response to the wait for re-establishing the first communication connection being less than a predetermined duration:
re-establish one or more channels for the first communication connection.

16. The system of claim 15, wherein the first communication connection uses connection-based communication protocol.

17. The system of claim 15, wherein the second communication connection uses broadcast-based communication protocol.

18. The system of claim 15, wherein the one or more processors are further configured to check for a response to the command, in case the command was submitted to the coordinate measurement device prior to a glitch in the first communication connection.

19. The system of claim 18, wherein the one or more processors are further configured to submit the command to the coordinate measurement device via the re-established first communication connection, in case the command was not submitted to the coordinate measurement device prior to a glitch in the first communication connection.

20. The system of claim 15, wherein the one or more processors are further configured to notify an operator of a communication failure in response to the wait for re-establishing the first communication connection being more than the predetermined duration.
